(19) United States
(12) Patent Application Publication
(10) Pub. No.: US 2023/0324077 A1
(43) Pub. Date: Oct. 12, 2023

(54) BLADE-HEATING HEAT PUMP COVER AND HEAT PUMP

(71) Applicant: BACKER HEATING TECHNOLOGIES (SHENZHEN) CO., LTD., Shenzhen (CN)

(72) Inventor: ZAIXING ZHOU, Shenzhen (CN)

(21) Appl. No.: 18/128,541

(22) Filed: Mar. 30, 2023

(30) Foreign Application Priority Data
Apr. 7, 2022 (CN) 202210361619.X

(51) Int. Cl. F24H 1/10; H05B 1/02; F24H 15/212

(52) U.S. Cl. CPC F24H 1/102; H05B 1/0244; F24H 15/212; F24H 2250/02

(57) ABSTRACT

Disclosed is a blade-heating heat pump cover and a heat pump. By providing the mounting slot on the cover body in a direction of protruding from the second surface to the first surface, and providing the heating element in the mounting slot, the application makes the heating element be provided on the cover body without contacting the liquid medium, and the liquid medium be heated through the cover body, thus avoiding the occurrence of leakage caused by corrosion of the heating element by the liquid medium; by providing the heating wire in the heating element, and bending and providing the heating wire in the first end of the heating element for heating, and one part of the heating wire being located on the second end of the heating element being connected to the external circuit, the application is easy to install, assembly and maintain.

### CROSS-REFERENCE TO RELATED APPLICATION

This application claims priority to Chinese Patent Application No. 202210361619.X, filed on Apr. 7, 2022, the content of all of which is incorporated herein by reference.

### TECHNICAL FIELD

The present disclosure relates to the technical field of heating appliance, in particular to a blade-heating heat pump cover and a heat pump.

### BACKGROUND

With the rapid development of science and technology, automated home appliances provide more functions to assist people's live, such as automatic dishwashers, water heaters, and water dispensers, etc. those appliances can drive the water flow through the pump body and heat the liquid in the pump body at the same time, thus providing convenience for people's live.

In the prior art, the heat tubes in the commercially available heat pumps are all tubular and provided in the interior of the pump body. Since the heating tubes are in direct contact with the liquid medium, the heating tubes are prone to corrosion with the increase of usage time, which can lead to current leakage, and result in the risk of electric shock during the use of the user.

Therefore, the technology still needs to be improved and developed.

### BRIEF SUMMARY

In order to solve the technical problems that the heating tubes of the heat pump in the prior art are tubular structures provided in the interior of the pump body, and the heating tubes are in direct contact with the liquid medium, which makes the heating tubes be easily corroded to cause current leakage, and brings the hidden danger to the users in installation and use, the present disclosure provides a blade-heating heat pump cover and a heat pump.

The technical solutions of the present disclosure are as follows:
A blade-heating heat pump cover comprises a cover body, the cover body comprises a first surface in contact with a liquid, and a second surface opposed to the first surface,
The cover body is provided with a mounting slot protruding from the second surface to the first surface, and the mounting slot is provided in a shape of a ring;
A heating element, the heating element is embeddedly provided on the mounting slot, the heating element comprises a first end located in the mounting slot and a second end protruding from the mounting slot, a heating wire is provided in the heating element, the heating wire is bent and provided in the first end, and the heating wire is connected to an external circuit on the second end.

In the blade-heating heat pump cover, the first end comprises a heating section and a non-heating section, the non-heating section is located on one side of the heating section away from the second end, and the heating section is fixedly connected to the second surface inside the mounting slot.

In the blade-heating heat pump cover, a length of the non-heating section is 3 mm-80 mm.

In the blade-heating heat pump cover, the non-heating section is bent relative to the second surface at a predetermined angle.

In the blade-heating heat pump cover, a ratio of a length along the radial direction of the heating element to a length along the axial direction of the heating element is not less than 2.3.

In the blade-heating heat pump cover, the heating element further comprises a bending section, the bending section is provided on the second end, a power density at a surface of the bending section is less than a power density at a surface of each other sections on the heating element.

In the blade-heating heat pump cover, a clamp section is provided inside the mounting slot, the clamp section is provided to protrude from the first surface to the second surface;

A matching section is provided on a part of the heating element corresponding to the clamp section, a shape of the matching section is adapted to a shape of the clamp section, the matching section is provided along a center line of the heating section, the heating wire is set on two sides of the matching section.

In the blade-heating heat pump cover, the heating section is set to have a predetermined distance between an inner side wall and an outer side wall of the mounting slot, and the predetermined distance is 1 mm to 100 mm.

In the blade-heating heat pump cover, an electrically-connected section is provided on the second end, the electrically-connected section is connected to the heating wire in circuit;

The blade-heating heat pump cover further comprises a temperature-controlling assembly, the temperature-controlling assembly is connected to the electrically-connected section in circuit, the temperature-controlling assembly is set on one side of the heating element corresponding to the second surface.

In the blade-heating heat pump cover, the electrically-connected section comprises a first wiring post and a second wiring post, and two ends of the heating wire are respectively connected to the first wiring post and the second wiring post;

The heating element further comprises a sheath, and an insulating filler. The heating wire is set inside the sheath, the insulating filler is filled in a position between the heating wire and the sheath.

In the blade-heating heat pump cover, the temperature-controlling assembly comprises a first plug and a second plug, the first plug is connected to the first wiring post in circuit, and the second plug is connected to the second wiring post in circuit.

In the blade-heating heat pump cover, the temperature-controlling assembly comprises:
A temperature-sensing piece, the temperature-sensing piece is fixedly fitted on one side of the first end corresponding to the second surface;
A positioning plate, a contour shape of the positioning plate is adapted to a contour shape of the temperature-sensing piece, the positioning plate is fixedly set on the temperature-sensing piece;
A temperature controller, a bottom of the temperature controller is embedded on a position of the positioning plate corresponding to the temperature-sensing piece.

A safety device, a bottom of the safety device is embedded on a position of the positioning plate corresponding to the temperature-sensing piece.

In the blade-heating heat pump cover, the temperature-sensing piece further comprises a first side plate and a second side plate, the first side plate and the second side plate are respectively fixedly connected to an inner side and an outer side of the heating element, and one side of the first side plate facing the cover body and one side of the second side plate facing the cover body are respectively fixedly connected to the second surface of the cover body.

In the blade-heating heat pump cover, the temperature-controlling assembly further comprises a controlling plug, the controlling plug is fixedly set on the temperature controller and the safety device.

In the blade-heating heat pump cover, the controlling plug further comprises a third plug and a fourth plug, a distance between the third plug and the fourth plug is 5 mm±0.5 mm, the third plug and the fourth plug are configured to connect a power supply.

In the blade-heating heat pump cover, a first mounting post and a second mounting post are fixedly provided on the temperature-sensing piece, the positioning plate is detachably fitted onto the first mounting post and the second mounting post.

In the blade-heating heat pump cover, a cross-sectional contour shape of the clamp section is one of a triangle, a semicircle, a rectangle, and a trapezoid.

A heat pump, the heat pump comprises the blade-heating heat pump cover according to any one of above.

The beneficial effects of the present disclosure are at least as follows: by providing the mounting slot on the cover body in a direction of protruding from the second surface to the first surface, and providing the heating element in the mounting slot, the present disclosure makes the heating element be provided on the cover body without contacting the liquid medium, and the liquid medium be heated through the cover body, thus avoiding the occurrence of leakage caused by corrosion of the heating element by the liquid medium; by providing the heating wire in the heating element, and bending and providing the heating wire in the first end of the heating element for heating, and one part of the heating wire being located on the second end of the heating element being connected to the external circuit, the present disclosure is easy to install, assembly and maintain.

### BRIEF DESCRIPTION OF THE DRAWINGS

FIG. 1 is a stereoscopic diagram of a structure of a blade-heating heat pump cover provided by the first embodiment of the present disclosure;

FIG. 2 is a cross-sectional view of the blade-heating heat pump cover provided by the first embodiment of the present disclosure;

FIG. 3 is an exploded view of the structure of the blade-heating heat pump cover provided by the first embodiment of the present disclosure;

FIG. 4 is a bottom view of the blade-heating heat pump cover provided by the first embodiment of the present disclosure;

FIG. 5 is a stereoscopic diagram of a structure of a blade-heating heat pump cover provided by the second embodiment of the present disclosure;

FIG. 6 is an exploded view of the structure of the blade-heating heat pump cover provided by the second embodiment of the present disclosure;

FIG. 7 is a stereoscopic diagram of a structure of a blade-heating heat pump cover provided by the third embodiment of the present disclosure;

FIG. 8 is an exploded view of the structure of the blade-heating heat pump cover provided by the third embodiment of the present disclosure;

FIG. 9 is a bottom view of a blade-heating heat pump cover provided by the third embodiment of the present disclosure;

FIG. 10 is a diagram of another structure of a heating element of a blade-heating heat pump cover provided by the present disclosure.

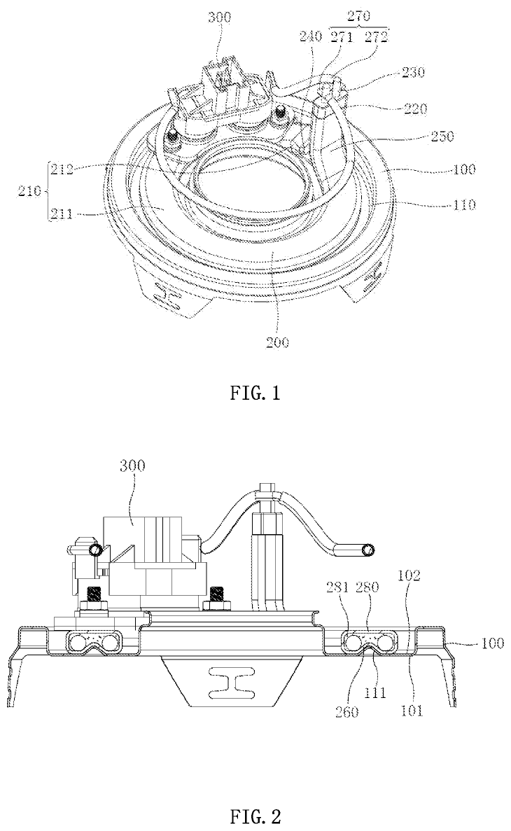

From FIG. 1 to FIG. 10: 100. cover body; 101. first surface; 102. second surface; 110. mounting slot; 111. clamp section; 200. heating element; 210. first end; 211. heating section; 212. non-heating section; 220 second end; 230. heating wire; 240. plug; 250. bending section; 260. matching section; 270. electrically-connected section; 271. first wiring post; 272. second wiring post; 280. sheath; 281. insulating filler; 300. temperature-controlling assembly; 301. first plug; 302. second plug; 310. temperature-sensing piece; 311. first side plate; 312. second side plate; 313. first mounting post; 314. second mounting post; 320. positioning plate; 330. temperature controller; 340. safety device; 350. control plug; 351. third plug; 352. fourth plug.

### DETAILED DESCRIPTION OF EMBODIMENTS

In order to make the objectives, the technical solutions, beneficial effects of the present disclosure more clearly understood, embodiments and drawings are given below to further illustrate the present disclosure. It is to be understood that the embodiments described herein are merely illustrative of the present disclosure and are not intended to be limiting.

It is noted that if there are directional indications (“top”, “bottom”, “left”, “right”, “front”, “back”, etc.) involved in the embodiments of the present disclosure, the directional indications are only used to explain the relative position relationship, the movement, etc. between the components in a particular position (as shown in the attached drawings), and if the particular position is changed, the directional indications are changed accordingly.

In addition, if there are descriptions involving “first”, “second”, etc. in the embodiments of the present invention. The descriptions of “first”, “second”, etc. are only used for descriptive purposes and are not to be understood as indicating or implying the relative importance, or implicitly specifying the number of technical features indicated. Thus, features limited with “first”, “second” etc. may explicitly or implicitly include at least one of the features. In addition, the technical solutions of each embodiment may be combined with each other, but only on the basis that the technical solutions can be realized by skilled in the art, and when the combination of the technical solutions is contradictory or unrealizable, it shall be considered that the combination of the technical solutions does not exist and is not within the scope of protection claimed by the present disclosure.

In the prior art, the heating tubes in the commercially available heat pump are tubular. The heating tubes are provided in the interior of the pump body, and the heating tubes are in direct contact with the liquid medium, with the increase of usage time the heating tubes are prone to corrosion, which leads to the risk of leakage, thus resulting in the risk of electric shock during the use of the user.

Based on the above technical problems in the prior art, the present disclosure provides a blade-heating heat pump cover. As shown in FIG. 1 and FIG. 2, the blade-heating heat pump cover comprises a cover body 100, the cover body 100 comprises a first surface 101 contacting a liquid, and a second surface 102 opposed to the first surface 101, characterized in that the cover body 100 is provided with a mounting slot 110 protruding from the second surface 102 to the first surface 101, the mounting slot 110 is provided in a shape of a ring; a heating element 200, the heating element 200 is embeddedly provided in the mounting slot 110, the heating element 200 comprises a first end 210 positioned in the mounting slot 110, and a second end 220 protruding from the mounting slot 110, the heating element 200 is provided with a heating wire 230, the heating wire 230 is bent and provided in the first end 210, and the heating wire is connected to an external circuit at the second end 220.

The present disclosure by providing the mounting slot 110 protruding from the second surface 102 to the first surface 101 on the cover body 100, and providing a heating element 200 inside the mounting slot 110, so that the heating element 200 is provided on the cover body 100 without contacting a liquid medium, by heating the liquid medium through the cover body 100, thus avoiding the occurrence of leakage caused by corrosion of the heating element 200 by the liquid medium, by providing the heating wire 230 inside the heating element 200, the heating wire 230 is bent and provided inside the first end 210 of the heating element 200 for heating, and a section of the heating wire 230 positioned at the second end 220 of the heating element 200 is connected to the external circuit, which is easy to install assembly and maintain.

In the above embodiment, as shown in FIG. 1, a main body of the blade-heating heat pump cover of the present disclosure is the cover body 100, which is used to connect and fix with a pump housing in household appliances, and the heating element 200 provided on the cover body 100 generates heat during a working process, which can realize the heating of a liquid medium contacting the cover body 100, so that users can use a heated liquid, and in this embodiment, in order to avoid the problem of short circuit easily occurring after a contact between the heating element 200 and the liquid medium with aging of usage time, the present disclosure provides the heating element 200 on one side of the cover body 100, and when the heating element 200 starts working, one side of a contact surface on the cover body 100 can heat the liquid medium by a heat conduction through the cover body 100.

To facilitate an explanation, as shown in FIG. 2, in a following embodiment one side of the cover body 100 contacting the liquid medium is the first surface 101, and one side of the cover body 100 opposed to the first surface 101 is the second surface 102, and the mounting slot 110 is provided protrudingly from one side of the second surface 102 on the cover body 100 to one side of the first surface 101, so that the heating element 200 is embedded and fixed in the mounting slot 110, and also a contact area between the cover body 100 and the liquid medium is increased, thus achieving an effect of increasing a heating speed of the liquid medium.

In the above embodiment, as shown in FIG. 1, a shape of the heating element 200 in the present disclosure is a rectangular shape similar to a blade, herein a purpose is to increase a contact area between the heating element 200 and the mounting slot 110, while to ensure that the heating element 200 and the mounting slot 110 fit closely, in an actual setting, the heating element 200 and the mounting slot 110 can be fixed by brazing and soldering and other welding methods, it should be noted to choose a heat-conducting material as a fixed material, while to completely fill a gap between the heating element 200 and the mounting slot 110 in order to improve a heat-conducting efficiency.

The heating wire 230 is also provided inside the heating element 200, and the heating wire 230 is made of a high-resistance alloy material, which can convert electrical energy into heat energy, and in this application, an electric heating wire is bent and provided inside the heating element 200 to ensure an uniformity of heat conduction, and for convenient description, the heating element 200 is also divided into the first end 210 and the second end 220 in the present disclosure, wherein the first end 210 of the heating element 200 is embedded in the mounting slot 110 for heating, and the second end 220 of the heating element 200 is protrudingly provided on an outside of the mounting slot 110, and the second end 220 is connected to the external circuit, herein easy to assemble in a producing process, while not to affect a length of the heating element 200 fitted with the mounting slot 110 to ensure a heating effect.

Further, as shown in FIG. 1, in an embodiment, the first end 210 also comprises a heating section 211 and a non-heating section 212, wherein the non-heating section 212 is located on one side of the heating section 211 away from the second end 220, and the heating section 211 is fixedly connected to the second surface 102 inside the mounting slot 110 herein providing the non-heating section 212 is to make an avoidance space occur between two ends of the heating element 200 surrounding the mounting slot 110, mainly aiming to facilitate an installation of a temperature-controlling assembly 300, so that the temperature-controlling assembly is not only sensitive to a temperature of the blade-heating heating element 200 but also sensitive to a temperature of the liquid, thus a fixed temperature difference existed between a sensed temperature by the temperature-controlling assembly 300 and the liquid in contact with the first surface 101 of the pump, and improving a temperature-controlling accuracy. In an actual setting, a length of the non-heating section 212 is from 3 mm to 80 mm, which can be adjusted by the skilled in the art according to an actual size of the cover body 100 and an accuracy requirement of temperature.

Specifically, as shown in FIG. 1, in an embodiment, the first end 210 of the heating element 200 has two forms of settings, one of which is to set the non-heating section 212 directly fitted to an inside of the mounting slot 110, and another of which is to bend the non-heating section 212 relative to the second surface 102 at a predetermined angle to facilitate an installation staff, and in an embodiment, it is also preferred to provide a plug 240 on the non-heating section 212 for protecting the heating element 200, and the plug 240 is made of an insulating material, which can realize a wrapping of one end of the heating element 200 to avoid a short circuit caused by the liquid entering into the heating element 200.

In an embodiment, in order to ensure a heat-conducting effect to a sheath 280, a ratio of a length of the heating element 200 along a radial direction to a length of an heating body along an axial direction in this application should be not less than 2.3, i.e. the heating element 200 in this application is set in a shape similar to a blade, so that the heating element 200 can be closely fitted in the mounting slot 110 during assembly, thus increasing a contact area between the heating element 200 and a bottom plate of the mounting slot 110, and improving a ratio of heat supply to ensure a fast heating process.

Further, as shown in FIG. 1, in an embodiment, the heating element 200 also comprises a bending section 250, the bending section 250 is set on the second end 220, an angle is set between the bending section 250 and the second surface 102 of the cover body 100, to achieve setting the second end 220 protruding out of the mounting slot 110, in a specific setting, a power density at a surface of the bending section 250 should be less than a power density at a surface of other sections of the heating body, i.e. the second end 220 where the bending section 250 is located is not involved in a heat conduction to the sheath 280, thus reducing a heat generated by the second end 220 to reduce energy loss.

In another embodiment of the present disclosure, as shown in FIG. 1 and FIG. 2, in another embodiment of the present disclosure, as shown in FIG. 2 and FIG. 4, in order to further improve a contact area between the heating element 200 and the bottom plate of the mounting slot 110 to improve a heat efficiency, in the embodiment also providing a clamp section 111 inside the mounting slot 110, the clamp section is provided along one side of the first surface 101 of the cover body 100 protruding to one side of the second surface 102, correspondingly, in the embodiment also providing a matching section 260 on a part of the heating element 200 corresponding to the clamp section 111, a shape of the matching section 260 is adapted to a shape of the clamp section 111, and in an actual setting, it is preferred to set the matching section 260 along a center line of the heating section 211, and at the same time, in the interior of the heating element 200, the bent heating wire 230 is fitted to two sides of the matching section 260 to achieve an effect of uniform heat conduction.

When the heating element 200 is fitted to the bottom of the mounting slot 110, the heating element 200 is set riding across the clamp section 111, increasing a contact area between the heating element 200 and the cover body 100 while also being able to position the heating element 200, effectively avoiding a problem of different mounting positions of the product heating element 200 due to factors such as welding, mounting order etc. during a producing process, and ensuring a consistency of a producing quality of the blade-heating heat pump cover.

In a specific setting, a cross-sectional contour of the clamp section 111 (matching section 260) may be set as triangle, semicircle, rectangle, trapezoid, etc. When the heating element 200 is placed in the mounting slot 110, the matching section 260 on the heating element 200 and the clamp section 111 automatically form a position adaption, thus limiting a mounting position of the heating element 200 and favorably improving an efficiency of production.

Further, in the above embodiment, as shown in FIG. 2, when the heating element 200 is set in the mounting slot 110, a predetermined distance is set between one side of the heating element 200 and an inner side wall of the mounting slot 110, and a predetermined distance is set between one side of the heating element 200 and an outer side wall of the mounting slot 110, with the predetermined distance ranging from 1 mm to 100 mm, there is an advantage of making a heat generated by the heating element 200 concentrate on a bottom part of the heating element 200 not involved in providing heat, and facilitating a part of the heating element 200 not involved in providing heat can quickly dissipate heat. In the embodiment, since the inner side wall and the outer side wall of the mounting slot 110 are not in direct contact with the heating element 200, thus also avoiding a risk of aging and accidental fire caused by a high temperature at a matching of an inlet pipe and a corresponding assembled pump housing with plastic and rubber material, and improving the pump body's life and increasing safety.

In an embodiment of the present disclosure, as shown in FIG. 1, an electrically-connected section 270 is set on the second end 220, the electrically-connected section 270 is connected to the heating wire 230 in circuit when in an actual setting, one function of the electrically-connected section 270 is to close the second end 220 of the heating element 200 to avoid water vapor, liquid, etc. from entering into the heating element 200 to cause a short circuit, and on the other hand for connecting with the temperature-controlling assembly 300; and

correspondingly, the above blade-heating heat pump cover also comprises the temperature-controlling assembly 300, the temperature-controlling assembly 300 is connected to the above electrical heating section 211 in circuit, and the temperature-controlling assembly 300 is fitted and set on one side of the above heating element 200 corresponding to the second surface 102. In an actual setting, the above electrically-connected section 270 comprises a first wiring post 271 and a second wiring post 272, and two ends of the above heating wire 230 are respectively connected with the first wiring post 271 and the second wiring post 272, and at the same time, a first plug 301 and a second plug 302 are set in the above temperature-controlling assembly 300, and the first plug 301 is connected with the above first wiring post 271 in circuit, the second plug 302 is connected with the second wiring post 272 in circuit, so that the temperature-controlling assembly 300 is connected with the heating wire 230 in the heating element 200 in circuit, in use through the temperature-controlling assembly 300 to supply electrical energy to the heating wire 230, achieving the heating wire 230 emergently powered off through the temperature-controlling assembly 300 when a temperature of the heating wire 230 overheating, thus avoiding an occurrence of electrical accidents.

In the above embodiment, the above heating element 200 also comprises the sheath 280, and an insulating filler 281, the above heating wire 230 is set inside the sheath 280, in order to avoid the heating wire 230 inside the heating element 200 from contacting the sheath 280 to occur a short circuit, the insulating filler 281 is filled in a gap between the heating wire 230 and the sheath 280, so as to achieve a fixed position of the heating wire 230 and an insulation, and a heat conduction.

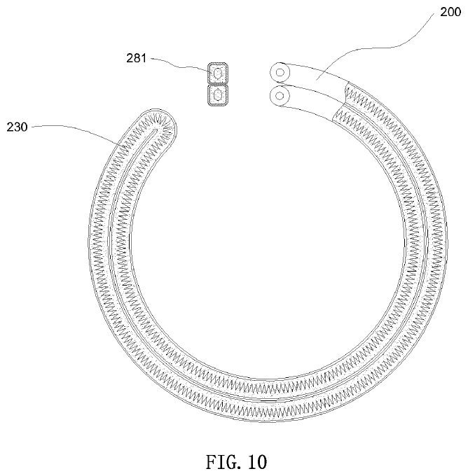

In the above embodiment, as shown in FIG. 10, the heating element 200 can be set up in a form of FIG. 10 in addition to structures of FIG. 1-FIG. 9 to achieve a same technical effect. In an actual setting, the above heating wire 230 can be set inside the sheath 280, and the gap between the heating wire 230 and the sheath 280 filled with the insulating filler 281. Firstly, a middle part of the heating wire 230 is bent, and then squeezed to form the blade type structure defined in this application, the advantage of which is that in an absence of special equipment to process the blade heating element 200 of FIGS. 1-9, a technical effect of professional equipment can be achieved through existing general-purpose equipment, reducing an amount of investment. Specifically, the above temperature-controlling assembly 300 specifically comprises: a temperature-sensing piece 310, a positioning plate 320, a temperature controller 330, a safety device 340, wherein the temperature-sensing piece 310 is used to form a fit with the above heating element 200 to achieve heat conduction, the positioning plate is used to fix the temperature controller 330 and the safety device, in an actual setting, the positioning plate 320 is provided with holes, bottom of the temperature controller 330 and the safety device 340 are respectively fixedly embedded in the holes, and are respectively against the temperature-sensing piece 310, thus achieving an effect of monitoring an temperature of the heating element 200.

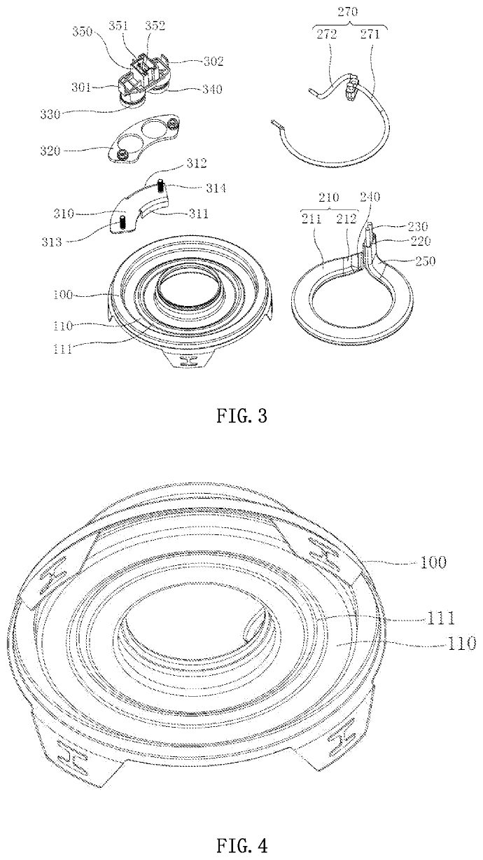

Further, as shown in FIG. 3, in the above embodiment, the above temperature-sensing piece 310 also comprises a first side plate 311 and a second side plate 312, wherein the first side plate 311 and the second side plate 312 are respectively clamped to an inner side and an outer side of the heating element 200, and are fixedly connected to the heating element 200, while one side of the first side plate 311 facing the cover body 100 and one side of the second side plate 312 facing the cover body 100 are respectively fixedly connected to the second surface 102 of the cover body 100 so that a heat of the liquid inside the pump can be conducted to the temperature-sensing piece 310 through the cover body 100. It should be noted that in the present application, a part of the temperature-sensing piece 310 that clamps the heating element 200 is the non-heating section 212 of the heating element 200, i.e. in an actual use, a part of the heating element 200 corresponding to the above temperature-sensing piece 310 does not heat up, the advantage of such a setting is that through the temperature-sensing piece 310 the temperature-controlling assembly 300 is sensitive not only to a temperature of the heating element 200, but also to a temperature of the liquid inside the pump, thus forming a temperature difference between the temperature-sensing piece 310 and the temperature of the liquid in a normal working stage, the temperature difference can improve a control accuracy of the temperature-controlling assembly 300 to the liquid temperature.

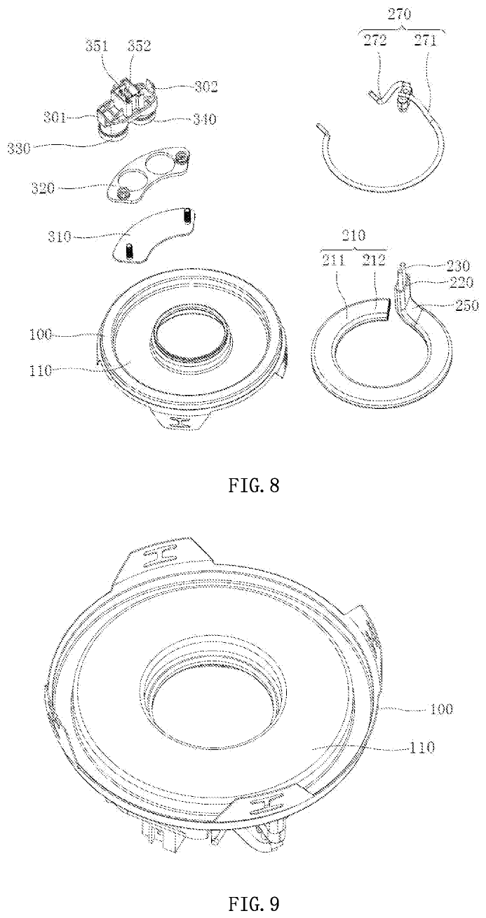

In addition, the present disclosure also provides one way of setting, as shown in FIG. 8, the temperature-sensing piece 310 in an actual setting may be set without the first side plate 311 and the second side plate 312, i.e. fixing the temperature-sensing piece 310 with the heating element 200 only by fitting the temperature-sensing piece 310 to the heating element 200. In the embodiment, a part of the temperature-sensing piece 310 is correspondingly provided in the heating section 211 of the heating element 200, and another part of the temperature-sensing piece 310 is provided in the non-heating section 212 of the heating element 200. A heat of the liquid in the pump may be conducted to the temperature-sensing piece 310 through the cover body 100 and a pipe wall of the non-heating section 212 of the heating element 200, so that the temperature-sensing sheet 300 may detect the heat of the liquid in the pump conducted through the non-heating section 212, and may also detect the heat of the heating element 200 conducted through the heating section 211, so that the temperature-controlling device mounted to the temperature-sensing piece 310 is sensitive to both the temperature of the heating element 200 and the temperature of the liquid. Thus achieving a same technical effect as the above embodiment of providing the first side plate 311 and the second side plate 312, and improving the control accuracy of the temperature-controlling assembly 300 to the liquid temperature.

In the above embodiment, as shown in FIG. 3, the above temperature-controlling assembly 300 also comprises a control plug 350, the control plug 350 is fixedly set on the temperature controller 330 and the safety device 340, in an actual setting, the control plug 350 may be specifically set using a connector such as RAST5 etc. to achieve an effect of connecting with power supply. In a specific embodiment, as shown in FIG. 3, the temperature controller 330 and the safety device 340 may be wrapped by a housing of the control plug 350 to ensure a stability of mounting, in the embodiment, two sides of the control plug 350 are also provided reinforcing bars, the reinforcing bars are used to support the two sides of the control plug 350 to avoid a deformation of the control plug 350 due to long-term stress concentration, and the above first plug 301 and the above second plug 302 are connected with the temperature controller 330 and safety device 340 in circuit respectively, thus achieve an effect of controlling a temperature of the heating body through the circuit.

In the above embodiment, as shown in FIG. 3, the control plug 350 also comprises a third plug 351 and a fourth plug 352, the third plug 351 and the fourth plug 352 are set at intervals and are parallel to each other, and the third plug 351 and the fourth plug 352 are respectively connected to the temperature controller 330 and the safety device 340 in circuit, through the third plug 351 and the fourth plug 352, connecting the control plug 350 to an external power supply may be achieved. In an actual setting, a distance between the third plug 351 and the fourth plug 352 should be limited to 5 mm±0.5 mm to achieve an effect of matching with a matching power connector.

Based on the above embodiment, in an implementable way of the present disclosure, as shown in FIG. 3, a first anti-shedding hole is also provided on the above third plug 351, and the first anti-shedding hole is pass-through set in the third plug 351, a tight connection between the third plug 351 and the matching power plug can be realized through the first anti-shedding hole to prevent shedding; correspondingly, a second anti-shedding hole is also pass-through set in the fourth plug 352. Through the second anti-shedding hole, an anti-shedding function of the tight connection between the fourth plug 352 and the matching power connector can be also achieved.

In an implementable way of the present disclosure, as shown in FIG. 3, in the above embodiment contour shapes of the temperature-sensing piece 310 and the positioning plate 320 are adapted to each other, and in order to realize a fixation of the temperature-controlling assembly 300, in this embodiment also providing a first mounting post 313 and a second mounting post 314 on the temperature-sensing piece 310, and the temperature-sensing piece 310 and the positioning plate 320 are fixed by fitting the positioning plate 320 onto the first mounting post 313 and the second mounting post 314, and the positioning plate 320 may be also limited by nuts.

Based on the above embodiments, the present disclosure may be combined to form three embodiments.

a first embodiment, as shown in FIG. 1 to FIG. 4:

in this embodiment, in the blade-heating heat pump cover, the mounting slot 110 of the cover body 100 is provided with the clamp section 111, a shape of the matching section 260 on the heating element 200 is adapted to a shape of the clamp section 111, and the heating element 200 is set riding across on the clamp section 111, and at the same time, in this embodiment the first side plate 311 and the second side plate 312 are provided on the temperature-sensing piece 310, and the temperature-sensing piece 310 is fixed on the heating element 200 and the cover body 100, and the temperature-controlling assembly 300 is fixed on the temperature-sensing piece 310, and a plug 240 is set on one end of the non-heating section 212 of the heating element 200 for protection. And please refer to the description above for settings of other structures in this embodiment.

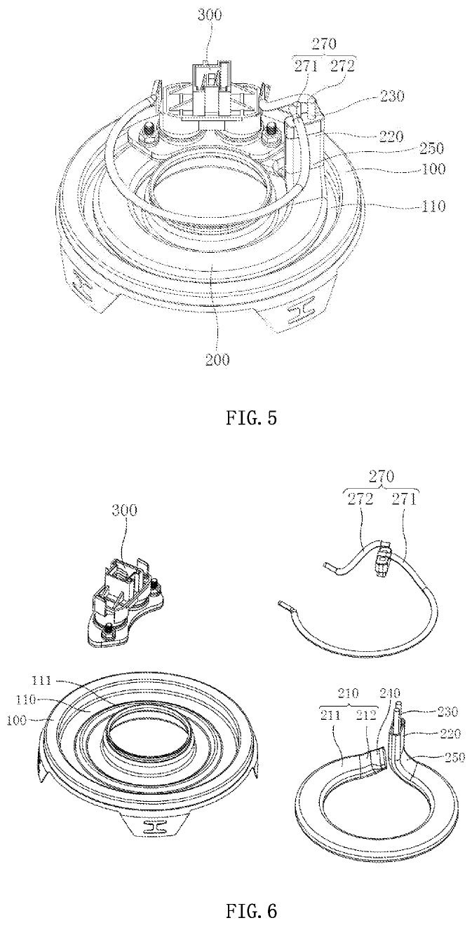

A second embodiment, as shown in FIG. 5 to FIG. 6:

in this embodiment, in the blade-heating heat pump cover, the mounting slot 110 of the cover body 100 is provided with the clamp section 111, a shape of the matching section 260 on the heating element 200 is adapted to a shape of the clamp section 111, the heating element 200 is set riding across the clamp section 111, and a plug 240 is also provided on one end of the non-heating section 212 of the heating element 200 for protection, and at the same time, in this embodiment not setting the first side plate 311 and the second side plate 312 on the temperature-sensing piece 310, and the temperature-sensing piece 310 is fitted on the heating section 211 and the non-heating section 212 on the heating element 200 to achieve an effect of monitoring the temperature of the liquid in the pump. And please refer to the description above for settings of other structures in this embodiment.

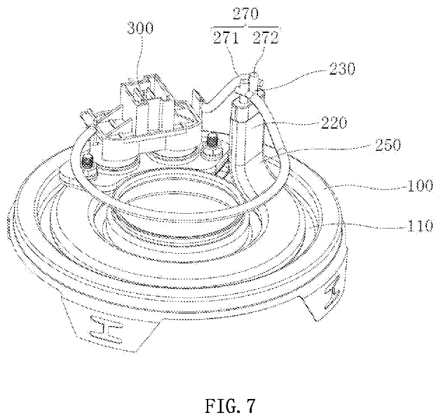

A third embodiment, as shown in FIG. 7 to FIG. 9, in this embodiment, a bottom plate of the mounting slot 110 of the cover body 100 is set horizontally, i.e. not setting the clamp section 111, correspondingly, one side of the heating element 200 corresponding to the mounting slot 110 is set to be flat, and the heating element 200 is directly embedded in the mounting slot 110, and at the same time, not setting the first side plate 311 and the second side plate 312 on the temperature-sensing piece 310. The temperature-sensing piece 310 is fitted on the heating section 211 and the non-heating section 212 of the heating element 200 to achieve the effect of monitoring the temperature of the liquid in the pump. In addition, not setting the plug 240 on the heating element 200, and the first end 210 of the heating element 200 is completely fitted in the mounting slot 110. And please refer to the description above for settings of other structures in this embodiment.

Based on the above embodiments, the present disclosure also provides a heat pump, the heat pump comprises the blade-heating heat pump cover as described in any one of the above embodiments, the blade-heating heat pump cover specifically comprises: a cover body 100, the cover body 100 comprising a first surface 101 in contact with a liquid, and a second surface 102 opposed to the first surface 101, characterized in that the cover body 100 is provided with a mounting slot 110 set protruding from the second surface 102 to the first surface 101, and the mounting slot 110 is provided in a shape of a ring; a heating element 200, the heating element 200 being embeddedly provided on the mounting slot 110, the heating element 200 comprising a first end 210 located in the mounting slot 110, and a second end 220 protruding from the mounting slot 110, the heating element 200 being provided with a heating wire 230, the heating wire 230 being bent and provided in the first end 210, and the heating wire 230 being connected to an external circuit on the second end 220. By providing the mounting slot 110 on the cover body 100 in a direction of protruding from the second surface 102 to the first surface 101, and providing the heating element 200 in the mounting slot 110, the present disclosure makes the heating element 200 be provided on the cover body 100 without contacting the liquid medium, and the liquid medium be heated through the cover body 100, thus avoiding the occurrence of leakage caused by corrosion of the heating element 200 by the liquid medium; by providing the heating wire 230 in the heating element 200, and bending and providing the heating wire 230 in the first end 210 of the heating element 200 for heating, and one part of the heating wire 230 being located on the second end 220 of the heating element 200 being connected to the external circuit, the present disclosure is easy to install, assembly and maintain.

In summary, the present disclosure provides a blade-heating heat pump cover and a heat pump, wherein, the blade-heating heat pump cover specifically comprises: a cover body 100, the cover body 100 comprising a first surface 101 in contact with a liquid, and a second surface 102 opposed to the first surface 101, characterized in that the cover body 100 is provided with a mounting slot 110 set protruding from the second surface 102 to the first surface 101, and the mounting slot 110 is provided in a shape of a ring; a heating element 200, the heating element 200 being embeddedly provided on the mounting slot 110, the heating element 200 comprising a first end 210 located in the mounting slot 110, and a second end 220 protruding from the mounting slot 110, the heating element 200 being provided with a heating wire 230, the heating wire 230 being bent and provided in the first end 210, and the heating wire 230 being connected to an external circuit on the second end 220. By providing the mounting slot 110 on the cover body 100 in a direction of protruding from the second surface 102 to the first surface 101, and providing the heating element 200 in the mounting slot 110, the present disclosure makes the heating element 200 be provided on the cover body 100 without contacting the liquid medium, and the liquid medium be heated through the cover body 100, thus avoiding the occurrence of leakage caused by corrosion of the heating element 200 by the liquid medium; by providing the heating wire 230 in the heating element 200, and bending and providing the heating wire 230 in the first end 210 of the heating element 200 for heating, and one part of the heating wire 230 being located on the second end 220 of the heating element 200 being connected to the external circuit, the present disclosure is easy to install, assembly and maintain.

It is to be understood that the present disclosure is not limited to the embodiments described above. Modifications and variations may be made according to the above description by those skilled in the art, all these modifications and variations should be considered as falling within the scope of the appended claims.

What is claimed is:

1. A blade-heating heat pump cover, comprising:
a cover body comprising a first surface in contact with a liquid, and a second surface opposed to the first surface, wherein the cover body is provided with a mounting slot protruding from the second surface to the first surface, and the mounting slot is provided in a shape of a ring; and
a heating element embeddedly provided on the mounting slot, the heating element comprising a first end located in the mounting slot and a second end protruding from the mounting slot, wherein a heating wire is provided in the heating element, wherein the heating wire is bent and provided in the first end, and the heating wire is connected to an external circuit on the second end.

2. The blade-heating heat pump cover according to claim 1, wherein the first end comprises a heating section and a non-heating section, wherein the non-heating section is located on one side of the heating section away from the second end, and the heating section is fixedly connected to the second surface inside the mounting slot.

3. The blade-heating heat pump cover according to claim 2, wherein a length of the non-heating section is 3 mm-80 mm.

4. The blade-heating heat pump cover according to claim 2, wherein the non-heating section is bent relative to the second surface at a predetermined angle.

5. The blade-heating heat pump cover according to claim 2, wherein a ratio of a length along the radial direction of the heating element to a length along the axial direction of the heating element is not less than 2.3.

6. The blade-heating heat pump cover according to claim 2, wherein the heating element further comprises a bending section, wherein the bending section is provided on the second end, and wherein a power density at a surface of the bending section is less than a power density at a surface of other sections on the heating element.

7. The blade-heating heat pump cover according to claim 1, wherein a clamp section is provided inside the mounting slot, wherein the clamp section is provided to protrude from the first surface to the second surface; and
a matching section is provided on a part of the heating element corresponding to the clamp section, wherein a shape of the matching section is adapted to a shape of the clamp section, wherein the matching section is provided along a center line of the heating section, and wherein the heating wire is set on two sides of the matching section.

8. The blade-heating heat pump cover according to claim 1, wherein the heating section is set to have a predetermined distance with an inner side wall and an outer side wall of the mounting slot, and the predetermined distance is 1 mm to 100 mm.

9. The blade-heating heat pump cover according to claim 1, wherein an electrically-connected section is provided on the second end, wherein the electrically-connected section is fixedly connected to the heating wire; and
the blade-heating heat pump cover further comprises a temperature-controlling assembly, wherein the temperature-controlling assembly is connected to the electrically-connected section in circuit, wherein the temperature-controlling assembly is set on one side of the heating element corresponding to the second surface.

10. The blade-heating heat pump cover according to claim 9, wherein the electrically-connected section comprises a first wiring post and a second wiring post, and two ends of the heating wire are respectively connected to the first wiring post and the second wiring post; and
the heating element further comprises a sheath, and an insulating filler, wherein the heating wire is set inside the sheath, wherein the insulating filler is filled in a position between the heating wire and the sheath.

11. The blade-heating heat pump cover according to claim 10, wherein the temperature-controlling assembly comprises a first plug and a second plug, wherein the first plug is connected to the first wiring post in circuit, and wherein the second plug is connected to the second wiring post in circuit.

12. The blade-heating heat pump cover according to claim 9, wherein the temperature-controlling assembly comprises:
a temperature-sensing piece fixedly fitted on one side of the first end corresponding to the second surface;
a positioning plate, wherein a contour shape of the positioning plate is adapted to a contour shape of the temperature-sensing piece, wherein the positioning plate is fixedly set on the temperature-sensing piece;
a temperature controller, wherein a bottom of the temperature controller is embedded on a position of the positioning plate corresponding to the temperature-sensing piece; and
a safety device, wherein a bottom of the safety device is embedded on a position of the positioning plate corresponding to the temperature-sensing piece.

13. The blade-heating heat pump cover according to claim 12, wherein the temperature-sensing piece further comprises a first side plate and a second side plate, the first side plate and the second side plate are respectively fixedly connected to an inner side and an outer side of the heating element, and one side of the first side plate facing the cover body and one side of the second side plate facing the cover body are respectively fixedly connected to the second surface of the cover body.

14. The blade-heating heat pump cover according to claim 12, wherein the temperature-controlling assembly further comprises a controlling plug fixedly set on the temperature controller and the safety device.

15. The blade-heating heat pump cover according to claim 14, wherein the controlling plug further comprises a third plug and a fourth plug, wherein a distance between the third plug and the fourth plug is 5 mm±0.5 mm, wherein the third plug and the fourth plug are configured to connect a power supply.

16. The blade-heating heat pump cover according to claim 12 wherein a first mounting post and a second mounting post are fixedly provided on the temperature-sensing piece, the positioning plate is detachably fitted onto the first mounting post and the second mounting post.

17. The blade-heating heat pump cover according to claim 7, wherein a cross-sectional contour shape of the clamp section is one of: a triangle, a semicircle, a rectangle or a trapezoid.

18. A heat pump comprising:
a blade-heating heat pump cover comprising a first surface in contact with a liquid, and a second surface opposed to the first surface,
wherein the cover body is provided with a mounting slot protruding from the second surface to the first surface, and the mounting slot is provided in a shape of a ring;
a heating element embeddedly provided on the mounting slot, the heating element comprising a first end located in the mounting slot and a second end protruding from the mounting slot, wherein a heating wire is provided in the heating element, wherein the heating wire is bent and provided in the first end, and wherein the heating wire is connected to an external circuit on the second end.

19. The heat pump cover according to claim 18, wherein the first end comprises a heating section and a non-heating section, wherein the non-heating section is located on one side of the heating section away from the second end, and wherein the heating section is fixedly connected to the second surface inside the mounting slot.
